(19) United States
(12) Patent Application Publication
(10) Pub. No.: US 2015/0198502 A1
(43) Pub. Date: Jul. 16, 2015

(54) METHODS AND SYSTEMS FOR AUTOMATED BRIDGE STRUCTURAL HEALTH MONITORING

(71) Applicant: Iowa State University Research Foundation, Inc., Ames, IA (US)

(72) Inventors: Brent Matthew Phares, Ankeny, IA (US); Yaohua Deng, Ames, IA (US); Junwon Seo, Ames, IA (US); Lowell Greimann, Ames, IA (US)

(21) Appl. No.: 14/595,931

(22) Filed: Jan. 13, 2015

Related U.S. Application Data
(60) Provisional application No. 61/927,219, filed on Jan. 14, 2014.

(51) Int. Cl. G01M 5/00; G01L 1/00

(52) U.S. Cl. CPC G01M 5/0008; G01L 1/00; G01M 5/0041

(57) ABSTRACT

In-situ methods and systems for determining bridge load ratings under ambient traffic are provided. These may include, for example, by installing one or more strain gauges on one or more bridge girders a batch of strain readings may be acquired from the one or more strain gauges. From the batch of strain readings, one or more strain time histories may be randomly sampled based, for example, on a girder peak strain. One or more vehicles may be randomly selected based on the one or more stored vehicle parameters by accessing a database with one or more stored vehicles and stored vehicle parameters. A bridge load rating model may be calibrated based on the one or more randomly sampled strain time histories and the randomly selected one or more vehicles for acquiring, in one embodiment, a bridge load rating distribution.

### CROSS REFERENCE TO RELATED APPLICATIONS

This application claims priority under 35 U.S.C. §119 to provisional applications U.S. Ser. No. 61/927,219 filed Jan. 14, 2014, herein incorporated by reference in its entirety.

### GRANT REFERENCE

This invention was made with government support under Grant No. TPF5219 awarded by Federal Highway Administration. The government has certain rights in the invention.

### BACKGROUND OF THE INVENTION

1. Field of the Invention

The present invention relates to methods and systems for bridge structural health monitoring. More specifically, but not exclusively, the present invention relates to automated methods and systems for determining bridge load ratings using ambient traffic.

2. Description of the Prior Art

Conventionally bridges are load rated (i.e., capacity) using codified approaches which make many assumptions about the behavior of each bridge. Given the codified nature, these ratings are often quite conservative. A better technique is to load the bridge using a controlled load (e.g., a known truck), measure the response of the bridge under that load, and then calibrate an analytical model which can then be used to compute the load rating. This technique requires that the bridge be briefly closed to traffic, puts test engineers in dangerous situations, and occurs at discrete points in time. These types of on-site controlled tests cannot be reasonably conducted due to spatial, time and cost restrictions, or difficulties associated with traffic disruption which may cause significant economic losses and inconvenience to users.

Therefore, it is an object, feature, or advantage of the present invention to use ambient traffic as the mechanism for measuring bridge response in place of a controlled load.

It is a further object, feature, or advantage of the present invention is to use ambient traffic as the mechanism for measuring bridge response in near real-time and continuously.

Another object, feature, or advantage of the present invention is to use ambient traffic as the mechanism for providing an indication of the need for bridge maintenance, repair, rehabilitation and replacement.

Since manual operations may not be most efficient for achieving many runs of load rating and deriving load rating distributions and may unintentionally produce operative errors, minimizing human attendance is considerably desired when regular load rating from ambient traffic is acquired.

Therefore, it is another object, feature, or advantage of the present invention is to use ambient traffic as a method and system for conducting in-situ determinations of bridge load ratings that overcome one or more of the problems associated with traditional approaches.

One or more of these and/or other objects, features or advantages of the present invention will become apparent from the specification and claims that follow.

### SUMMARY OF THE INVENTION

The present invention provides automated methods and systems for determining bridge load ratings using ambient traffic.

One exemplary embodiment provides an in-situ method for determining bridge load ratings under ambient traffic. In one aspect, one or more gauges may be installed on one or more bridge support members. A batch of readings may be selected from the one or more gauges resulting for a detected vehicle and one or more vehicles may be selected from a database based on one or more parameters of the detected vehicle. A bridge load rating model may be calibrated based on at least one factor relating to the collected batch of strain readings and the selected one or more vehicles. A bridge load rating distribution may also be acquired from the calibrated bridge load rating model.

Another embodiment provides a system for in-situ determinations of bridge load ratings under ambient traffic. The system may include one or more deck bottom sensors operably connected to one or more bridge support members and a data store with a batch of sensor readings from the one or more deck bottom sensors. The batch of sensor readings is for a detected vehicle. A database may be configured to include one or more vehicles with one or more parameters associated with the detected vehicle. A bridge load rating model may be calibrated based on at least one factor relating to the batch of sensor readings and the one or more vehicles representative of the detected vehicle. A bridge load rating distribution may be computed, for example, using the bridge load rating model.

Yet another embodiment provides an in-situ method for determining bridge load ratings under ambient traffic. The method may include any one or combination of the following steps. For example, by installing one or more strain gauges on one or more bridge girders a batch of strain readings may be acquired from the one or more strain gauges. From the batch of strain readings, one or more strain time histories may be randomly sampled based, for example, on a girder peak strain. One or more vehicles may be randomly selected based on the one or more stored vehicle parameters by accessing a database with one or more stored vehicles and stored vehicle parameters. A bridge load rating model may be calibrated based on the one or more randomly sampled strain time histories and the randomly selected one or more vehicles for acquiring, in one embodiment, a bridge load rating distribution.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a flowchart for both manual and automatic procedures of bridge load ratings in accordance with an illustrative embodiment;

FIGS. 2A-B is a pictorial representation of a bridge layout with gauges in accordance with an illustrative embodiment;

FIGS. 3A-B is a pictorial representation of strain peaks induced by a five-axle vehicle in accordance with an illustrative embodiment; and

FIGS. 4A-B is a pictorial representation of frequency histograms of gross vehicle weight and maximum girder strains in accordance with an illustrative embodiment;

FIGS. 5A-D is a pictorial representation of frequency histograms of axle spacings in accordance with an illustrative embodiment;

FIG. 6 is a pictorial representation of locations for one or more gauges in accordance with an illustrative embodiment;

FIG. 7 is a pictorial representation of a finite element model of a bridge in accordance with an illustrative embodiment;

FIG. 8 is a pictorial representation of axle and wheel configurations for a vehicle in accordance with an illustrative embodiment;

FIGS. 9A-C is a pictorial representation of comparison of strain time histories between test data and finite element results using known vehicles in accordance with an illustrative embodiment;

FIG. 10 is a pictorial representation of frequency histograms of minimum rating factors using different sampling strategies in accordance with an illustrative embodiment;

FIGS. 11A-B is a pictorial representation of frequency histograms of I_{G1} and I_{G2} using difference sampling strategies in accordance with an illustrative embodiment; and

FIGS. 12A-C is a pictorial representation of comparison of stain time histories between test data and finite element results using ambient traffic in accordance with an illustrative embodiment.

### DETAILED DESCRIPTION OF THE PREFERRED EMBODIMENTS

Bridge load rating based on on-site, controlled test results is sometimes not implemented due to spatial, time and cost restrictions and difficulties associated with traffic interruption. Continuous load rating of bridges with a Structural Health Monitoring (SHM) system that relies on ambient traffic is an effective solution. It also provides a timely indication of the need for bridge maintenance, repair, rehabilitation and replacement. This present invention provides, for example, methods and systems for an automated ambient traffic approach for determining load ratings of bridges under ambient traffic. In one embodiment, multiple batches of strain responses induced by a vehicle, such as five-axle trucks in a lane, are randomly selected from the SHM system records. In one embodiment of the invention, multiple trucks may be randomly sampled from a historical weight-in-motion (WIM) database. For each combination of strain response and truck selection, a Finite Element (FE) model may be calibrated and used to calculate the load rating. In still another embodiment of the present invention, five random sampling strategies are developed for selecting strain responses and truck parameters as described herein. One experimental approach uses a sample three-span, two-girder, and two-lane steel girder/concrete deck bridge. Initially, load rating of the bridge using the Traditional Known Truck Approach may be performed to provide information for validating the adequacy of the methods and systems of the present invention. The FE model may be calibrated using each of the known trucks and relevant strain responses, and the resulting calibrated FE model may be used to calculate a bridge load rating. The results of the calibration and load rating may be derived and compared to those using the Traditional Known Truck Approach so as to select the best sampling strategy. According to one approach, a sampling strategy with strain time histories having higher girder strain peaks and larger gross vehicle weights is beneficial.

To determine the most accurate bridge load ratings, on-site controlled tests using known trucks crossing the bridge may be conducted to collect actual bridge responses. Truck or other vehicle parameters such as transverse and longitudinal positions, gross vehicle weight, axle weight, and axle spacings may be measured during a test. With the test data and known truck parameters, bridge load carrying capacity can be assessed by analyzing the test data and calibrating FE models. The aforementioned method for bridge load rating is often referred to as the Traditional Known Truck Approach. However, in some situations, on-site controlled tests cannot be reasonably conducted due to spatial, time and cost restrictions, or difficulties associated with traffic disruption which may cause significant economic losses and inconvenience to users. In these cases, the continuous load rating of bridges using the methods and systems of the present invention, such as a Structural Health Monitoring (SHM) system, that relies on ambient traffic provide a solution. Thus, according to one aspect of the present disclosure, an Automated Ambient Traffic Approach is disclosed. Further, the approaches of the present invention provide a timely indication of the need for bridge maintenance, repair, rehabilitation and replacement.

Unlike during controlled testing, when a bridge is subjected to ambient traffic with unknown trucks, both the bridge responses and the truck parameters should be considered as random variables. In addition, bridge parameters such as member stiffnesses should also be treated as random variables because of differences between construction and design, variations in composite action level, and deterioration. All of these random variables possess probability distributions varying with time. Accordingly, methods and systems of the present invention evaluate, for purposes of illustration, bridge responses induced by five-axle trucks traveling the south-lane of the bridge and truck parameters selected from a Weight-In-Motion (WIM) database were utilized to calibrate finite element models. Bridge rating factors were calculated using analytical models calibrated from the measured strains following the AASHTO Load Factor Rating (LFR) method. Frequency histograms of the rating factors may be developed to take into account uncertainties of the truck parameters and the bridge responses and their correlations.

What follows are embodiments for methods and systems of the present invention, including an Automated Ambient Traffic Approach for determining load ratings of steel girder bridges under ambient traffic.

### EXPERIMENTAL

### Methods and Systems for an Automated Ambient Traffic Approach Bridge Model Calibration and Load Rating

Bridge load ratings are available, for example, using a set of commercially available software applications, including WinGen, one for bridge model generation and load test simulation, and WinSac, one for structural analysis, model calibration, and load rating computation. WinSac provides algorithms for making direct numeric comparisons between measured and computed strains. Bridge parameters may be calibrated through a process of minimizing the difference between the measured and computed strains using a least squares approach. Four different statistical values, absolute error (AE), percent error (PE), scale error (SE) and correlation coefficient (CC), may be used to describe a model's ability to represent the actual structure, and can be determined by:

$$\begin{matrix}AE = \sum \vert {ɛ}_{R} - {ɛ}_{C} \vert & ( 1 ) \\ PE = \frac{\sum {( {ɛ}_{R} - {ɛ}_{C} )}^{2}}{\sum {ɛ}_{R }^{2}} & ( 2 ) \\ SE = \frac{\sum max {\vert {ɛ}_{R} - {ɛ}_{C} \vert}_{gage}}{\sum max {\vert {ɛ}_{R} \vert}_{gage}} & ( 3 ) \\ PE = \frac{\sum ( {ɛ}_{R} - {μ}_{{ɛ}_{R}} ) ( {ɛ}_{c} - {μ}_{{ɛ}_{c}} )}{\sum \sqrt{{( {ɛ}_{R} - {μ}_{{ɛ}_{R}} )}^{2} {( {ɛ}_{c} - {μ}_{{ɛ}_{c}} )}^{2}}} & ( 4 )\end{matrix}$$

where, ε_{R}=Measured strains; ε_{C}=Strain calculated using the FE model; max|ε_{R}−ε_{C}|_{gage}=Maximum absolute strain differences in each gage; max|ε_{R}|_{gage}=Maximum absolute strain in each gage; μ_{ε}_{_{R}}=Average recorded strains in each gage; μ_{ε}_{_{R}}=Average calculated strains in each gage.

The calibrated bridge FE model may be used to perform a load rating using WinSac. The load rating factor (RF) is calculated using the Load Factor Rating (LFR) Method per AASHOTO standard Specifications:

$$RF = \frac{C - {A}_{1} D}{{A}_{1} L ( 1 + I )} \qquad ( 5 )$$

where, C=the capacity of the member; D=The dead load effect on the member; L=the live load effect on the member; I=the impact factor for live load effect; A₁=factor for dead load, equals 1.3; A₂=factor for the live load, equals 2.17 for inventory level.

### Process Automation

A strain-based structural health monitoring (SHM) system developed to remotely monitor bridges for damage detection may be utilized to assess the load carrying capacity of bridges under ambient traffic. Although non-automated systems exist, these require manual operations for each step of the calibration and load rating process. For instance, a bridge model may be updated with the inclusion of strain responses, truck parameters and calibrated bridge parameters manually using WinGen; the bridge model may be calibrated and load rated manually executing WinSac, respectively. Dependent manual operations should be automated due to at least two reasons. First, manual operations may unintentionally produce operative errors. Secondly, manual operations are not efficient for achieving many runs of load rating and deriving load rating distributions. In other words, minimizing human attendance is considerably desired when regular load rating from ambient traffic is desired.

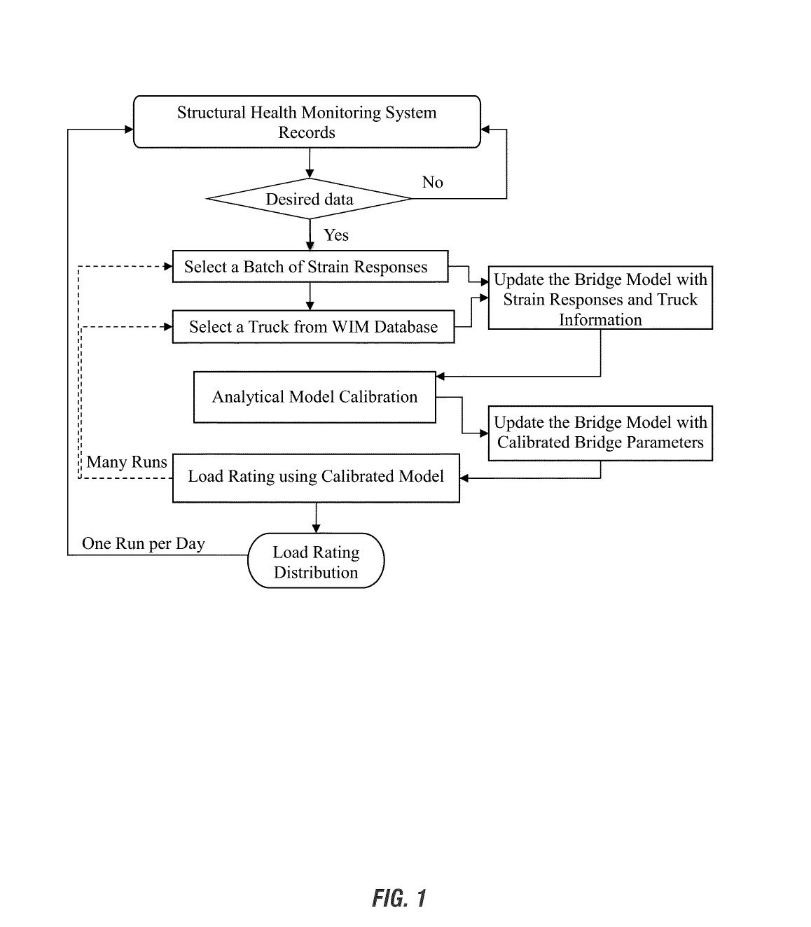

Accordingly, the present invention provides automated methods and systems for determining bridge load ratings using ambient traffic, including an Automated Ambient Traffic Approach that is capable of operating fully autonomous or with very little user intervention. FIG. 1 provides a pictorial representation of an automated step-by-step procedure in accordance with one exemplary aspect of the present disclosure. The operations within the flowchart may be achieved using custom-developed programming that essentially replaces the Graphical User Interface with text-based manipulations. For instance, the bridge FE model may be updated by revising the model output file and the computations for calibration and load rating are performed by calling the analytical routine (i.e., WinSac). During operation, an application may be automatically initiated at the end of each day to complete the bridge model calibration and load rating as shown, by way of example, in FIG. 1.

### Truck/Vehicle Detection

Based on the methods and systems of the present disclosure, one-truck event and its associated travel lane can be accurately detected using the strains on the deck bottom, while other occurrence events with more than one truck simultaneously on the bridge may be abandoned. The events with one five-axle non-concurrent truck in the south lane may be extracted from a database having one or more system records, which is taken as the desired data in the flowchart in FIG. 1. One batch of strain responses in girders and the deck induced during one of the detected events may be selected for each calibration and load rating. The detected truck information may also be used to select trucks/vehicles from the WIM database.

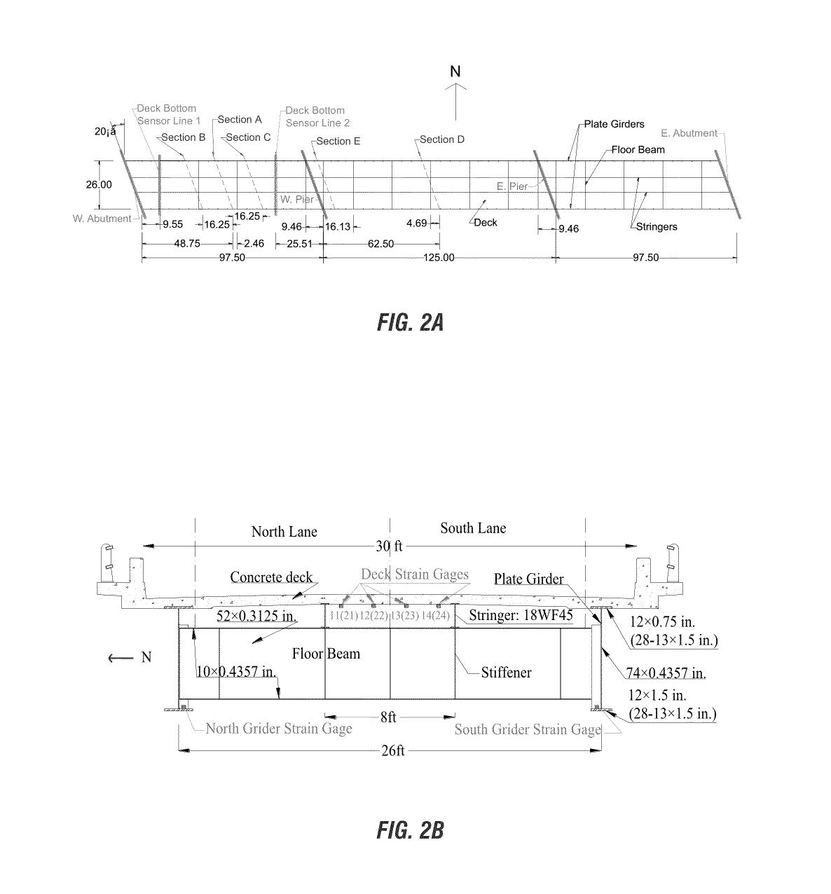

Truck parameters used for bridge model calibration may consist of axle spacings, travel position, gross vehicle weight, axle weight, and transverse position. Axle spacings and travel position can be detected using the strains recorded by deck bottom sensor lines 1 and 2, as illustrated in FIG. 2A. FIG. 2B shows four strain gages placed at the deck bottom at sensor line 1 (sensors 11, 12, 13 and 14) and sensor line 2 (21, 22, 23, and 24), respectively. The truck speed (V) can be determined by:

V=d₁₂/t₁₂ (6)

where, d₁₂=the distance between the two deck bottom sensor lines; t₁₂=the time duration that the truck travels from sensor line 1 to sensor line 2.

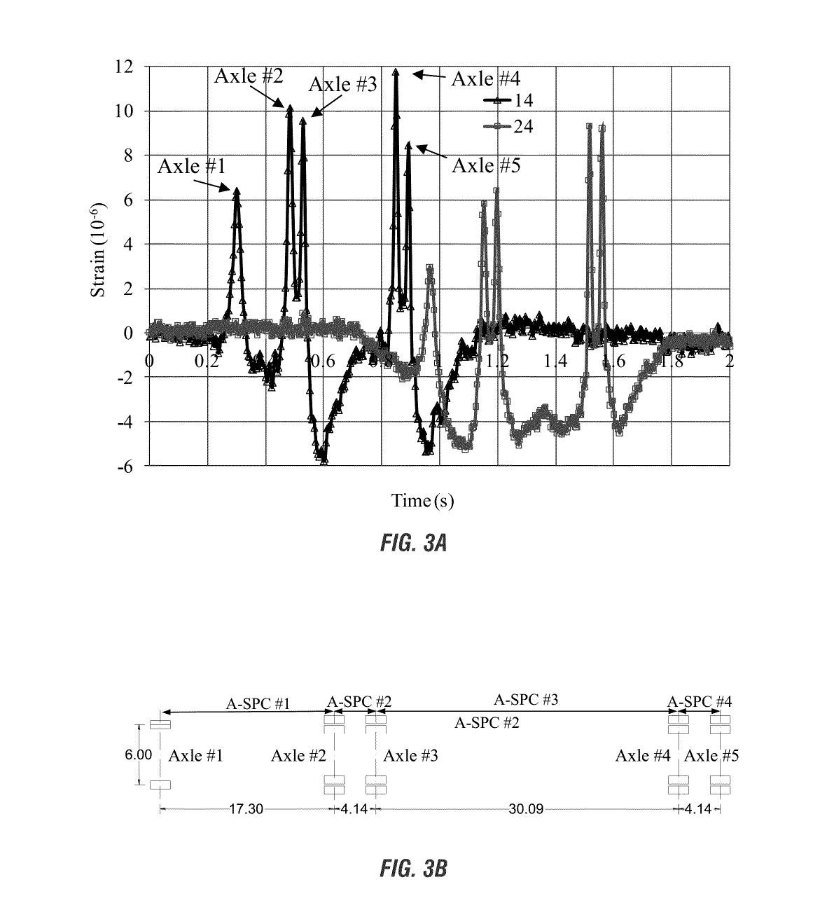

To illustrate a process of axle detection, two longitudinally aligned sensors 14 and 24 may be used as an example. The axle spacings may be determined as the product of the speed and the timestamp differences between adjacent strain peaks in either sensor 14 or 24. The travel position of the truck/vehicle can be correlated with the girder and deck strain data using the truck speed, timestamps of deck strain peaks and locations of sensor lines. Five strain peaks, detected in the two sensors 14 and 24, represent five axles of a truck, as shown in FIGS. 3A and 3B. Five truck speeds can be calculated by Eq. (6). The values of the five speeds should be close if the peaks are induced by a five axle truck. It is noted that the wheels on the driver side, detected by the strain gages, are located approximately 2 ft away from deck sensors.

### Sampling Strategies

The load rating results using the methods and systems of the present disclosure, including, for example, an Automated Ambient Traffic Approach depend upon the sampling strategy, which is used to select strain responses and select trucks from the WIM Database as shown in the flowchart in FIG. 1. FIG. 1 indicates that either one batch or several batches of strain time histories can be sampled from SHM system per day, and either one truck or several trucks can be sampled corresponding to each batch of strain time histories from the WIM database. One truck and one batch of strain time histories are used for each calibration and load rating.

The magnitudes of truck/vehicle parameters may be correlated to those of bridge girder strains. For instance, a large strain peak in the bottom flange of the girder mid-span section is likely related to one of the heavier trucks. However, due to the influences of axle spacings, transverse position and axle weight, the largest strain peak may not always induced by the heaviest truck. Thus, some uncertainties may still exist. Although, the axle spacings and travel position of the truck can be accurately determined using the SHM system as described in the aforementioned section. To take into account uncertainties in the transverse position of the truck, it is assumed that the truck travels in the center of the lane minus/plus 2 ft (0.61 m) following a uniform distribution.

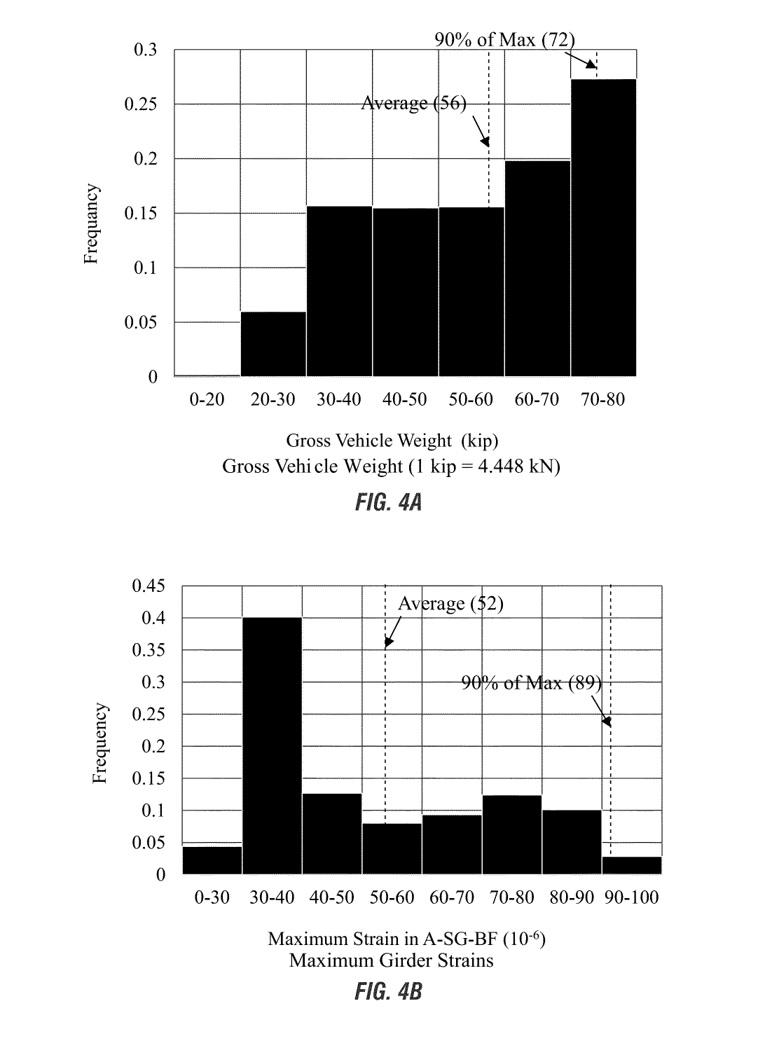

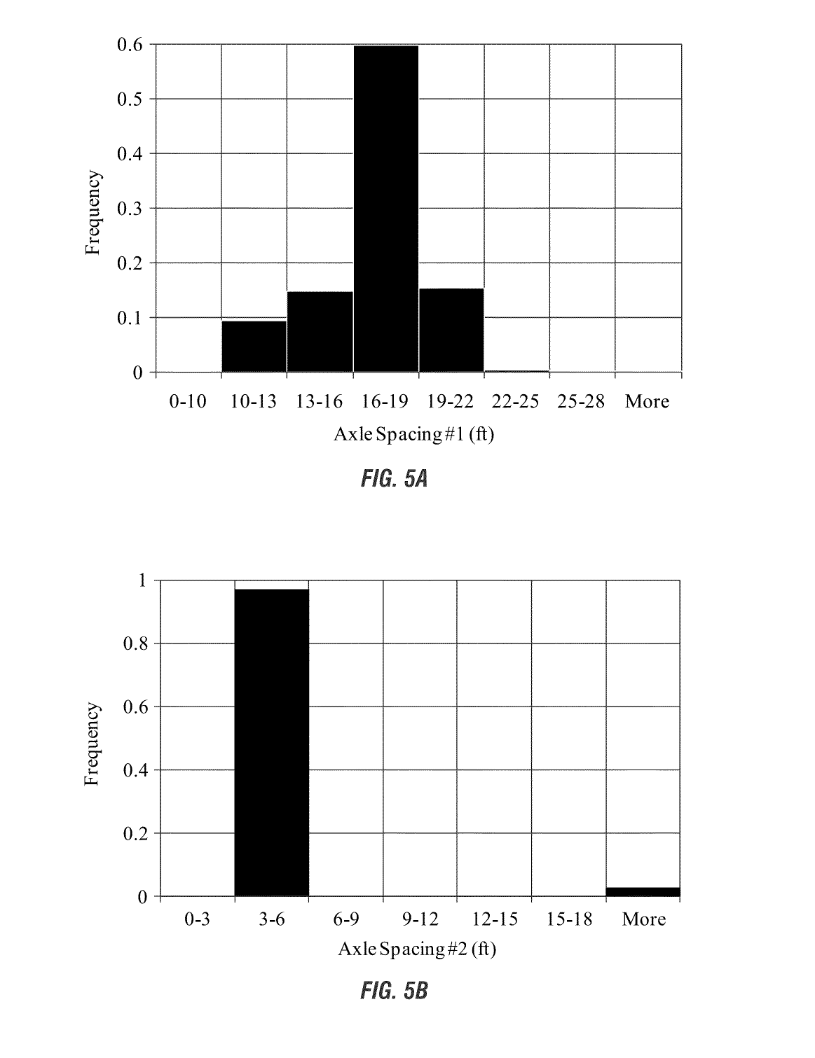

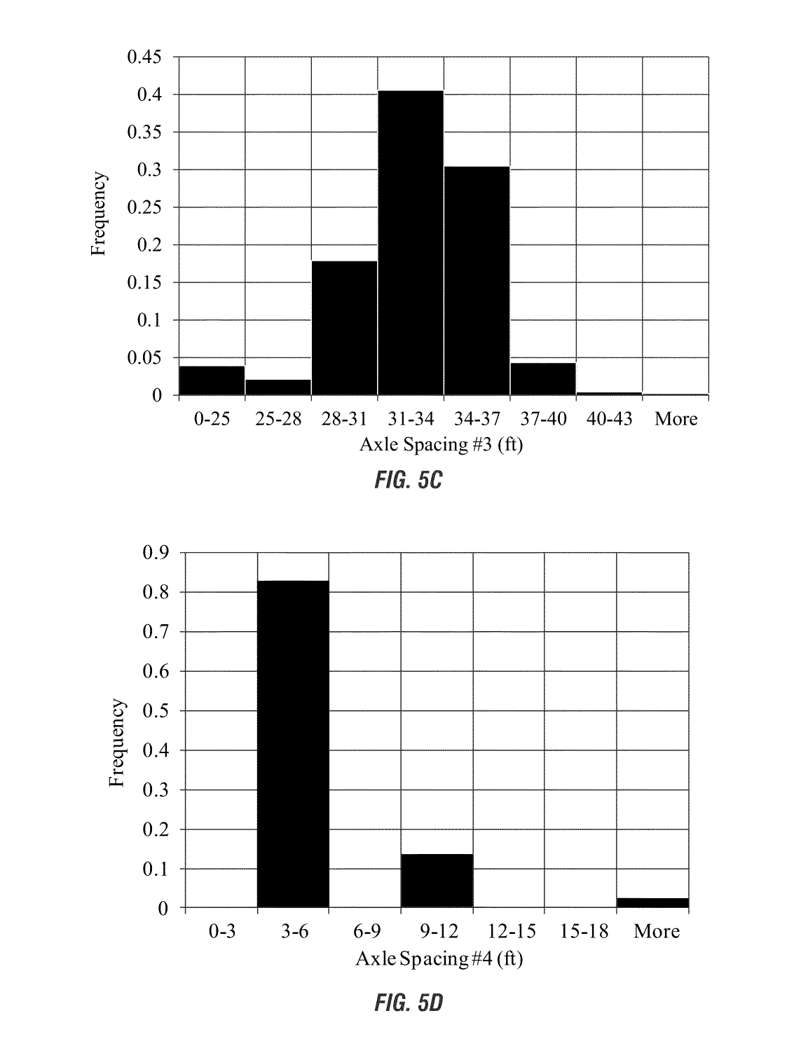

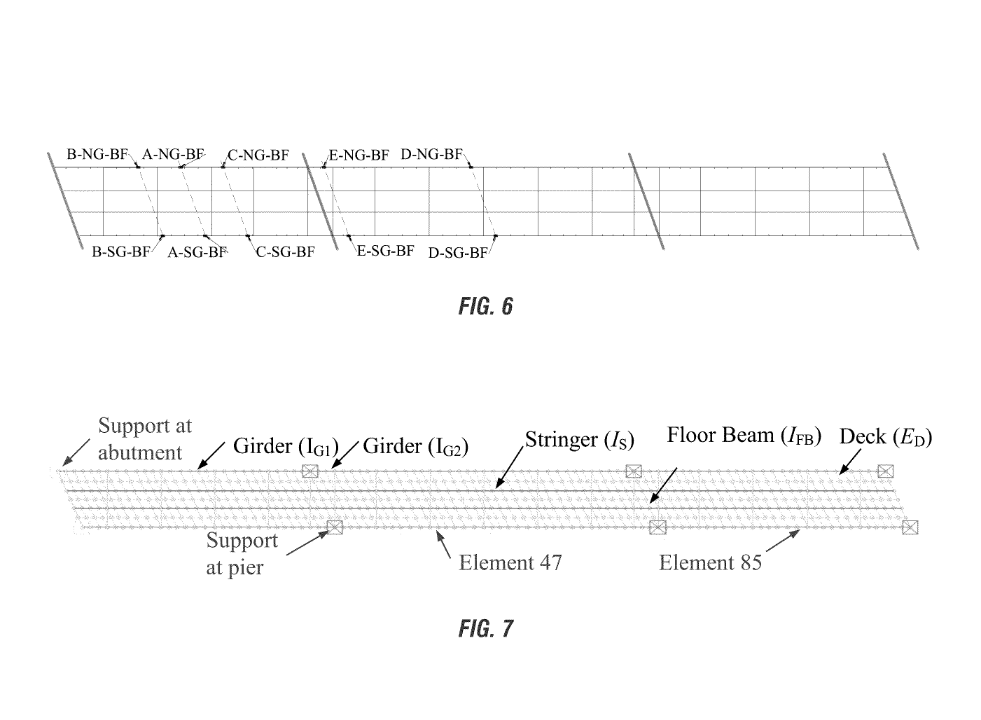

One state-specific WIM database with 190,259 five-axle trucks, established in Iowa during 2009-2011, may be used to describe the uncertainties of axle weight and gross vehicle weight. The frequency histogram of gross vehicle weights less than 80 kips (356 kN) is shown in FIG. 4A. FIG. 4B is the frequency histogram for girder strain peaks in sensor A-SG-BF (FIG. 6) from 386 five-axle truck south-lane events detected in the SHM system. Note that the histograms in FIGS. 4A and 4B are not similar. In other words, as noted above the relationship between truck weight and peak strain may not be significant. This may be mainly due to the fact that the WIM database is established using four-direction heavy traffic near an interstate highway while the strains in the bridge induced by the east bound light traffic highway. FIGS. 5A-D show frequency histograms of axle spacings based on WIM database, which indicate that the common ranges for axle spacings #1, #2, #3, and #4 are 10-22 ft (3.05-6.71 m), 3-6 ft (0.91-1.83 m), 25-40 ft (7.62-12.19 m), and 3-6 ft (0.91-1.83 m), respectively. The bridge girder strains associated with five-axle trucks with axle spacings within these ranges may be used for bridge model calibration. Further, due to the precision of the axle detection method, the values of the detected axle spacings minus/plus 0.8 ft (0.24 m) may be used as the one of the criteria to select trucks/vehicles (i.e., truck/vehicle parameters) from WIM database.

Five sampling strategies may be introduced to account for the uncertainties of gross vehicle weight and axle weight, as tabulated in Table 1, below. For each strategy, the batches of strain time histories are randomly selected based on the range of girder strain peak, and the trucks are randomly selected based on the range of gross vehicle weight along with the axle spacings derived from the selected batch.

TABLE 1
Sampling Strategies of Strain Time Histories and Five-axle Trucks

| | Selection of Strain | | Selection of Five-axle Trucks | | |
|---|---|---|---|---|---|
| | Time Histories | | Amount | | |
| | Amount | Girder Strain | Number of | | Gross |
| Sampling | of | Peak | trucks for | | Vehicle |
| Strategies | Batches | (macros) | Each Batch | Total | Weight (kip) |
| Strategy #1 | 300 | 15-100 | 1 | 300 | 20-80 |
| Strategy #2 | 30 | 52-100 | 10 | 300 | 56-80 |
| Strategy #3 | 1 | 52-100 | 300 | 300 | 56-80 |
| Strategy #4 | 10 | 89-100 | 30 | 300 | 72-80 |
| Strategy #5 | 1 | 89-100 | 300 | 300 | 72-80 |

Each batch of strain time histories represents bridge responses induced by one five-axle truck event and measured by the sensors A-SG-BF, A-NG-BF, D-SG-BF, D-NG-BF, E-SG-BF, and E-NG-BF at sections A, D and E as shown in FIG. 6. Note that the letters “A”, “D” and “E” refer to the section locations, “SG” and “NG” represent the south and north girders respectively, “BF” refers to the bottom flange of girders. As shown in Table 1, strategy #1 has no limits for girder strain peak and gross vehicle weight, strategies #2 and #3 have strain peaks and weights higher than the average girder strain peak and the average gross vehicle weight respectively, and strategies #4 and #5 have strain peaks and weights higher than 90% of the maximum girder strain peak and 90% of the maximum gross vehicle weight respectively. Strategies #1, #2, #3, #4 and #5 have 300 batches of strain time histories and 300 trucks, 30 batches of strain time histories and 10 trucks, and 1 batch of strain time histories and 300 trucks, and 10 batches of strain time histories and 30 trucks, respectively, as shown in Table 1. The total number of calibration and load rating for each sampling strategy is 300. Note that the strain of 52 macros and the weight of 56 kips (249 kN) in Table 1 are the average girder strain peak and the average gross vehicle weight, respectively. The strains of 89 macros and the weight of 72 kips (320 kN) in Table 1 are the 90% of the largest girder strain peak and the 90% of the largest gross vehicle weight, respectively.

### FE Modeling of a Demonstration Bridge

### US-30 Bridge

The US-30 bridge crossing the South Skunk River near Ames, Iowa, was used to demonstrate the process of bridge load rating determination. The US-30 bridge has three spans with a 20 degree-skew, total length of 320-ft (97.5-m) and width of 30-ft (9.1-m). The bridge supports two east bound traffic lanes with a posted speed limit of 65 miles per hour (mph, 105 km/h). The 7.25-in (184-mm) thick cast-in-place reinforced concrete deck is supported by a framing system consisting of two stringers, nineteen floor beams, and two welded plate girders. The plate girders are continuous over the three spans, (i.e., 97.5 ft [29.7 m] end spans and a 125.0 ft [38.1 m] main span), while the stringers are continuous over the floor beams. FIGS. 2A and 2B illustrates the layout, typical cross section and the dimensions of the structural components of the bridge. The girder flanges taper from 28 in.×1.5 in. (711 mm×38 mm) to 13 in.×1.5 in. (330 mm×38 mm) within the negative moment region as shown in FIG. 2B and the girders are spliced at locations 30 ft from both piers. The spacings between the girder and the stringer and between stringers are 9 ft (2.7 m) and 8 ft (2.4 m), respectively. The bridge supports were designed to be rollers at both abutments and at the east pier and pinned at the west pier. The abutments and the piers are stub reinforced concrete and monolithic concrete, respectively.

### FE Modeling

An FE model of US-30 bridge is established as shown in FIG. 7. Exterior girders, interior stringers, and floor beams are modeled using 2-node beam elements, which have three translational and three rotational degrees of freedom at each node. The deck may be modeled using 4-node quadrilateral shell elements, which have three translational and three rotational degrees of freedom at each node and is only incorporated with bending behavior (ignoring tension membrane behavior). Linear elastic material models are used for the concrete and steel, respectively.

Bridge parameters, which may be calibrated in an FE model, commonly consist of girder moments of inertia, stringer moments of inertia, floor beam moments of inertia and the elastic modulus of the deck. For example, with the US-30 bridge, the five bridge parameters to be calibrated, as illustrated in FIG. 7, are moments inertia of girder cross-sections away from piers (IG1), moment inertia of girder cross-sections near piers (IG2), moment inertia of stringer cross-sections (IS), moment inertia of floor beam cross-sections (IFB), and modulus of elasticity of deck (ED), and their values and ranges are calculated and tabulated in Table 2, below. The initial values of the moment of inertia of floor beams (IFB) and elastic modulus of deck are set as plan values, and upper and lower limits are set as 25% higher and 25% lower than the plan values, respectively. The initial values of the girders and the stringers are set as plan values considering fully composite actions with deck and railings. The upper and lower limits of the moments of inertia of the girders and stringers are set as 25% higher than plan values considering fully composite action and 25% lower than plan values considering non-composite action, respectively. The spring constants at abutments accounting for support restraint will not be included in the bridge model.

TABLE 2
Parameter Values and Ranges of the US 30 Bridge

| | Non-composite | Composite | Lower | Upper |
|---|---|---|---|---|
| Parameter | Plan Value | Plan Value | Limit | Limit |
| I_{G1}, in⁴ | 36,180 | 172,342 | 27,135 | 215,427 |
| I_{G2}, in⁴ | 102,427 | 266,545 | 76,820 | 333,181 |
| I_{S}, in⁴ | 691 | 2,824 | 519 | 3,530 |
| I_{FB}, in⁴ | 14,097 | 14,097 | 10,570 | 17,621 |
| E_{D}, ksi | 3,834 | 3,834 | 2,876 | 4,793 |

### Load Rating Using Traditional Known Truck Approach

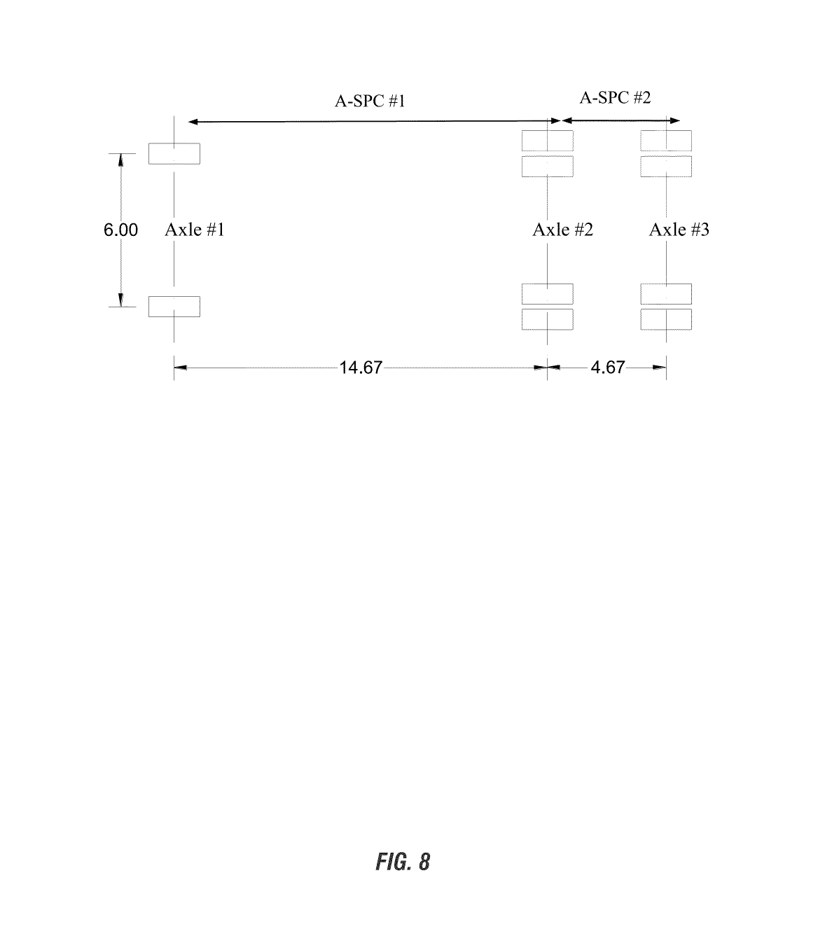

Load rating using the Traditional Known Truck Approach may be performed to provide information to validate the adequacy of the methods and systems of the present invention, including an Automated Ambient Traffic Approach. Field tests were conducted using trucks with known parameters, speed and transverse positions. Five three-axle dump trucks, employed as the control truck in those tests, have the same configurations and different truck weight. The axle and wheel configurations of the dump trucks are illustrated in FIG. 8 and the axle spacings, the axle weight and the total weight of the trucks are summarized in Table 3, below. During the test, the right lane was first closed for testing and then the left lane. Only the test data, which were not significantly affected by the traffic in the other lane open to normal traffic, are selected. For each lane testing, the trucks were traveling in the lane center at either highway speed or crawl speed.

TABLE 3
Parameters of Three-Axle Dump Trucks

| | A-SPC | A-SPC | A-WT | A-WT | A-WT | GVW, |
|---|---|---|---|---|---|---|
| ID | #1, ft | #2, ft | #1, kip | #2, kip | #3, kip | kip |
| Truck_W2 | 14.67 | 4.67 | 13.08 | 11.97 | 11.97 | 37.02 |
| Truck_W4 | | | 13.60 | 19.39 | 19.39 | 52.38 |
| Truck_W5 | | | 11.66 | 9.08 | 9.08 | 29.82 |
| Truck_W6 | | | 11.10 | 6.99 | 6.99 | 25.08 |
| Truck_W7 | | | 12.58 | 12.2 | 12.2 | 36.98 |

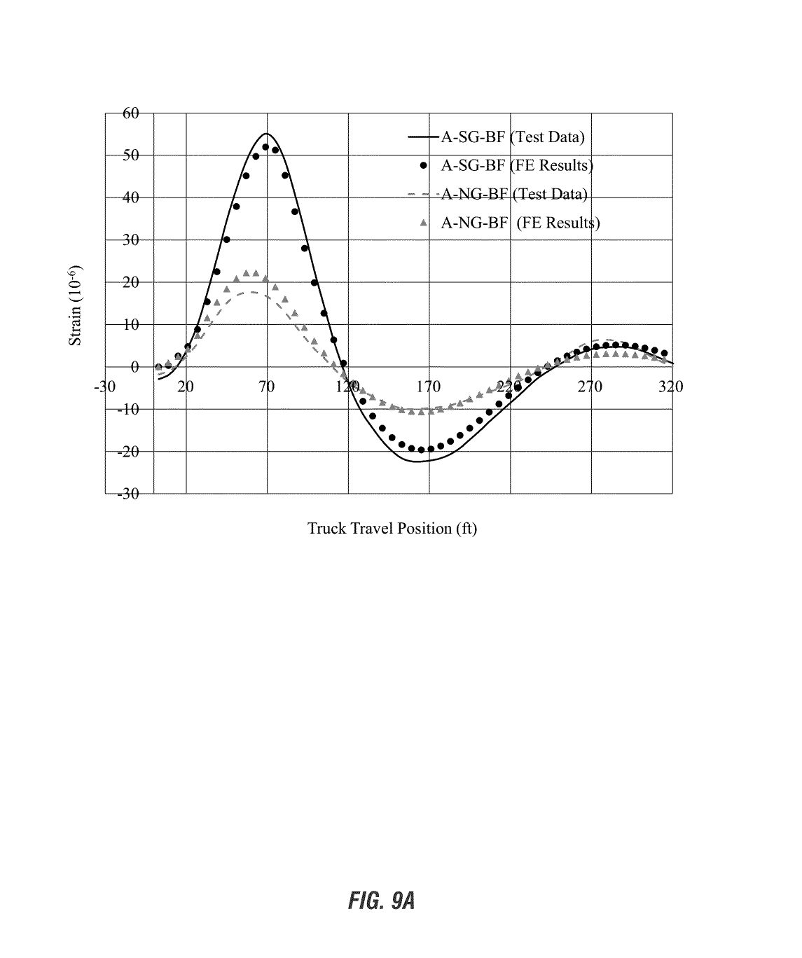

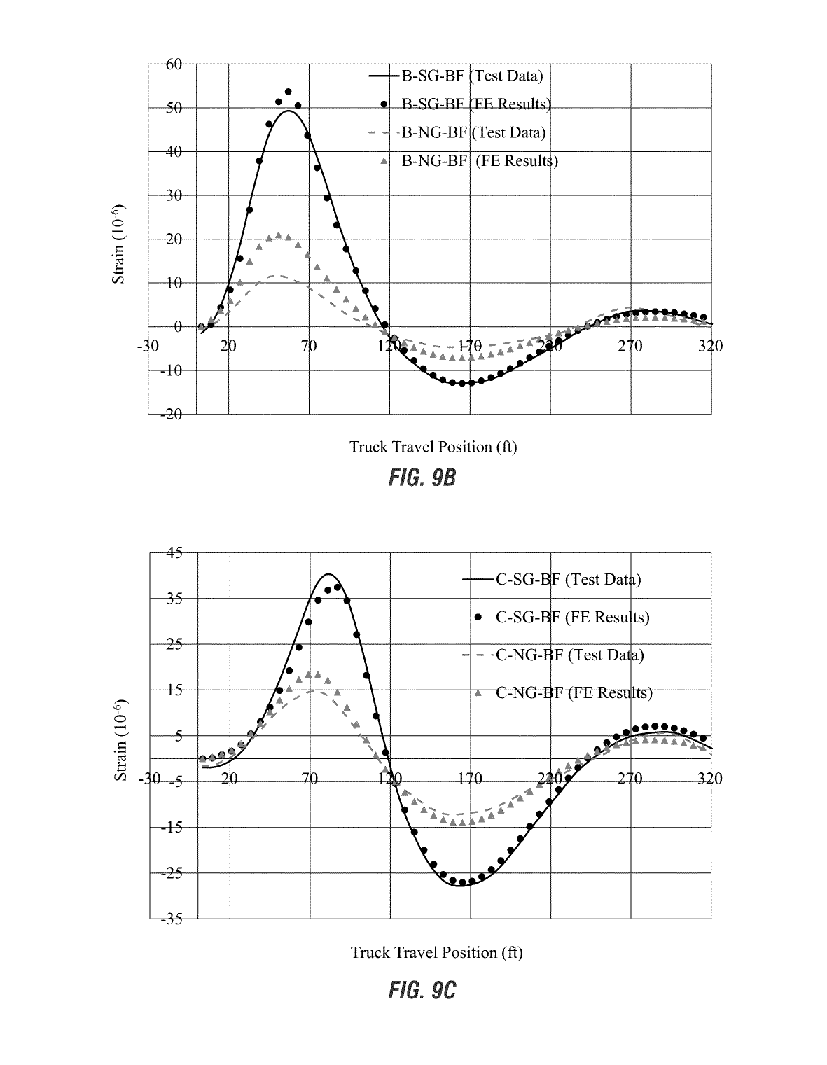

Six strain gages were placed at the bottom flanges of the south and north girders at sections A, B and C as shown in FIG. 6, i.e., A-SG-BF, A-NG-BF, B-SG-BF, B-NG-BF, C-SG-BF, and C-NG-BF. The letters “A”, “B” and “C” refer to the section locations, “SG” and “NG” represent the south and north girders respectively, “BF” refers to the bottom flange of girders. For each test, one batch consisting of six strain time histories is used to calibrate the FE model of US-30 Bridge. The calibrated values for each calibration of bridge parameters are shown in Table 4, below. Additionally, the statistical values illustrating the accuracy of each calibration are shown in Table 4. Small errors (e.g., percent error and scale error) and correlation coefficient larger than 0.98, were generally found. Note that only the load carrying capacities of south and north girders are evaluated because the strains in the girder bottom flanges are used for bridge model calibration. For instance, the batch of strain time histories calculated using FE modeling with Truck_W2 at speed of 59.4 mph (95.6 km/h) are in good agreement with those from test data, as shown in FIG. 9A, 9B, 9C for sections A, B and C respectively.

TABLE 4
Calibration and Load Rating Results using the Traditional Known Truck Approach

| | | | | | | | | | | | | Min. | |
|---|---|---|---|---|---|---|---|---|---|---|---|---|---|
| | Speed, | Travel | I_{G1}, | I_{G2}, | I_{S}, | I_{FB}, | E_{d}, | AE, | PE, | SE, | | Rating | Critical |
| ID | mph | Lane | in⁴ | in⁴ | in⁴ | in⁴ | ksi | 10⁻⁶ | % | % | CC | Factor | Element |
| Truck_W2 | 6.5 | South | 186,100 | 333,200 | 3,530 | 10,570 | 2,876 | 858 | 1.8 | 1.7 | 0.9913 | 1.30 | 85 |
| | 6.9 | | 195,200 | 249,300 | 1,385 | 10,570 | 2,876 | 880 | 1.8 | 2.7 | 0.9915 | 1.26 | 47 |
| | 59.4 | | 190,000 | 269,900 | 2,679 | 10,570 | 2,876 | 947 | 2.3 | 2.9 | 0.9885 | 1.35 | 85 |
| Truck_W4 | 56.5 | South | 169,900 | 245,300 | 3,530 | 10,570 | 2,876 | 856 | 2.8 | 1.4 | 0.9878 | 1.32 | 85 |
| | 55.9 | | 196,100 | 278,800 | 3,530 | 10,570 | 2,888 | 948 | 2.7 | 3.1 | 0.9874 | 1.31 | 85 |
| | 7.1 | North | 208,000 | 254,800 | 1,402 | 11,010 | 2,996 | 789 | 3.4 | 1.9 | 0.9828 | 1.24 | 47 |
| | 56.2 | | 194,900 | 261,000 | 3,451 | 14,960 | 3,112 | 688 | 3.6 | 1.6 | 0.9828 | 1.29 | 47 |
| Truck_W5 | 56.2 | North | 204,700 | 303,600 | 3,451 | 17,180 | 2,996 | 425 | 3.2 | 3.0 | 0.9843 | 1.30 | 85 |
| | 55.3 | | 201,100 | 278,300 | 3,451 | 17,180 | 3,070 | 440 | 3.3 | 2.8 | 0.9834 | 1.29 | 85 |
| Truck_W6 | 56.2 | North | 195,500 | 255,200 | 3,451 | 15,300 | 3,235 | 805 | 3.3 | 3.3 | 0.9841 | 1.28 | 47 |
| Truck_W7 | 55.9 | North | 191,200 | 256,500 | 3,451 | 17,180 | 4,673 | 426 | 3.5 | 1.9 | 0.9846 | 1.30 | 47 |

| | | | | | | | | | | | |
|---|---|---|---|---|---|---|---|---|---|---|---|
| Mean | 193,882 | 271,445 | 3,028 | 13,242 | 3,134 | 733 | 2.9 | 2.4 | 0.9862 | 1.29 | N/A |
| Standard Deviation | 10,182 | 26,455 | 844 | 3,072 | 524 | 207 | 0.7 | 0.7 | 0.0032 | 0.03 | N/A |

The minimum rating factors are also shown in Table 4. The minimum rating factors for all the cases occur in the element 85 at the east span or the element 47 at the center span of the south girder, as shown in FIG. 7. This may be less than the ideal situation in which one would desire that the strain data would be available near the controlling rating factor location. In these calibration cases, the strain gauges used for calibration are located in the west span. However, the calibrated parameter values represent the relative stiffness among different bridge components indicating the load distribution to those components. The strength capacities (C) of components do not rely on the bridge model calibration. The rating factor as calculated by Eq. (5) is dependent on the effects of distributed dead load and live load to each component. Therefore, as long as the relative stiffness among components is reasonably calibrated, the rating factors can be well determined although the bridge parameter values are dispersed to some extent using different model calibrations as shown in Table 4. Table 4 also indicates that the bridge model calibration and load rating are not sensitive to the truck speed and travel lane. The mean and standard deviation of the bridge parameters, statistical values and minimum rating factors are also calculated in Table 4.

Load Rating using Automated Ambient Traffic Approach

Calibration and load rating results using the methods and systems of the present disclosure, including for example an Automated Ambient Traffic Approach, using different sampling strategies are summarized and compared with those using the Traditional Known Truck Approach in Table 5. Likewise, only the load carrying capacity of south and north girders are evaluated because the strains in the girder bottom flanges are used for bridge model calibration. The mean and standard deviation of converged parameter values, statistical values, and minimum rating factors are calculated for 300 runs of calibration and load rating using each sampling strategy.

As indicated in Table 5, when using sampling strategies #2, #3, #4, or #5, means and standard deviations of percent and scale errors are small and correlations are larger than 0.99; the means and standard deviations of the four statistical values and minimum rating factors are comparable to those obtained using known trucks, even though some dispersions of mean and standard deviation of bridge parameter values are found compared with those obtained using known trucks as shown in Table 5. However, unacceptable mean and standard deviation of percent and scale errors are derived using the sampling strategy #1. The critical elements are 87 or 45 for strategy #1 and element 87 for strategy #2, #3, #4 and #5 as shown in Table 5 and FIG. 7.

TABLE 5
Calibration and Load Rating Results using the Automated Ambient Traffic Approach through Different Sampling Strategies

| | | | | | | | | | | | | | Critical |
|---|---|---|---|---|---|---|---|---|---|---|---|---|---|
| | | | | | | | | | | | | Min. | Element |
| | | | I_{G1}, | I_{G2}, | I_{S}, | I_{FB}, | E_{d}, | AE, | PE, | SE, | | Rating | (Figures |
| Type of Trucks | | | in⁴ | in⁴ | in⁴ | in⁴ | ksi | 10⁻⁶ | % | % | CC | Factor | 5A-D) |
| Known Trucks | | Mean | 193,882 | 271,445 | 3,028 | 13,242 | 3,134 | 733 | 2.90% | 2.40% | 0.9862 | 1.29 | 85 or 47 |
| | | Standard | 10,182 | 26,455 | 844 | 3,072 | 524 | 207 | 0.70% | 0.70% | 0.0032 | 0.03 | |
| | | Deviation | | | | | | | | | | | |
| Ambient | Strategy | Mean | 158,929 | 251,093 | 3,383 | 13,735 | 3,894 | 2,917 | 30.75% | 8.80% | 0.9729 | 1.35 | 85 or 47 |
| Traffic | #1 | Standard | 55,269 | 80,361 | 428 | 3,217 | 882 | 2,316 | 52.01% | 8.92% | 0.0211 | 0.06 | |
| | | Deviation | | | | | | | | | | | |
| | Strategy | Mean | 168,905 | 275,188 | 3,441 | 13,864 | 3,786 | 1,227 | 3.38% | 3.41% | 0.9900 | 1.34 | 85 |
| | #2 | Standard | 23,109 | 31,747 | 252 | 3,223 | 892 | 257 | 1.79% | 0.96% | 0.0060 | 0.02 | |
| | | Deviation | | | | | | | | | | | |
| | Strategy | Mean | 177,363 | 288,192 | 3,479 | 13,137 | 3,939 | 1,156 | 2.87% | 3.83% | 0.9935 | 1.34 | 85 |
| | #3 | Standard | 19,956 | 24,960 | 74 | 3,148 | 892 | 212 | 1.36% | 0.89% | 0.0031 | 0.02 | |
| | | Deviation | | | | | | | | | | | |
| | Strategy | Mean | 161,185 | 250,827 | 3,092 | 12,650 | 3,166 | 1,026 | 2.44% | 3.20% | 0.9906 | 1.33 | 85 |
| | #4 | Standard | 15,507 | 19,873 | 903 | 3,058 | 642 | 335 | 2.05% | 1.13% | 0.0066 | 0.02 | |
| | | Deviation | | | | | | | | | | | |
| | Strategy | Mean | 153,379 | 247,389 | 3,318 | 13,694 | 3,499 | 874 | 1.65% | 2.51% | 0.9954 | 1.34 | 85 |
| | #5 | Standard | 10,800 | 7,480 | 532 | 3,340 | 858 | 140 | 0.69% | 0.75% | 0.0023 | 0.02 | |
| | | Deviation | | | | | | | | | | | |

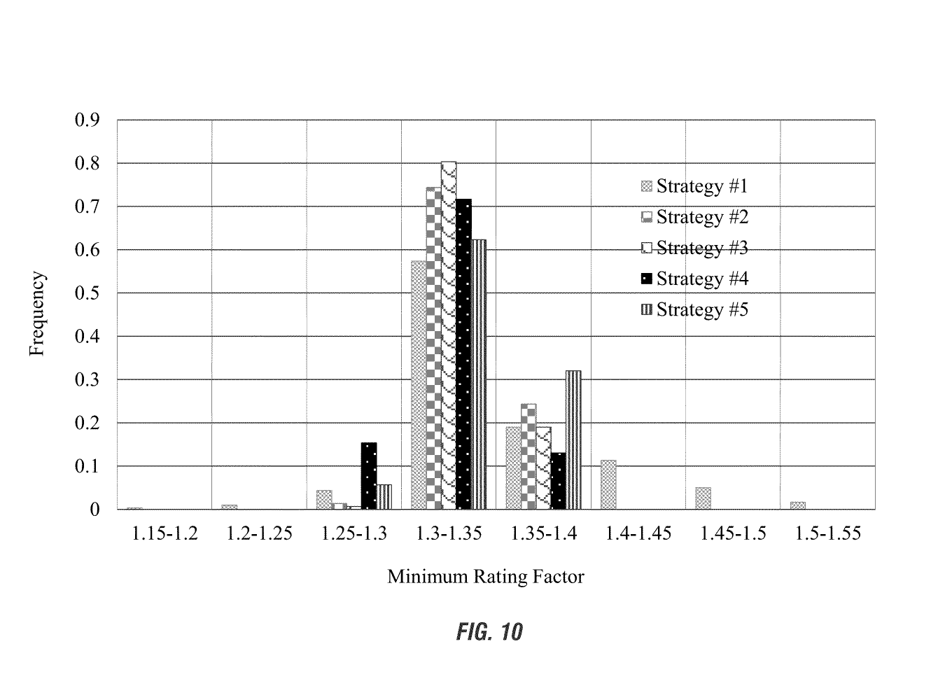

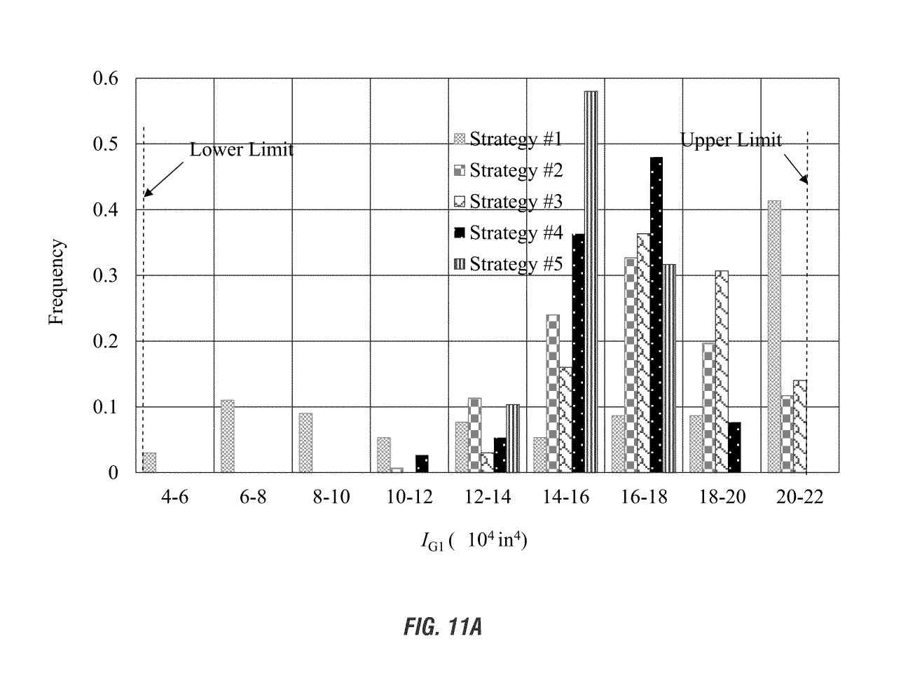

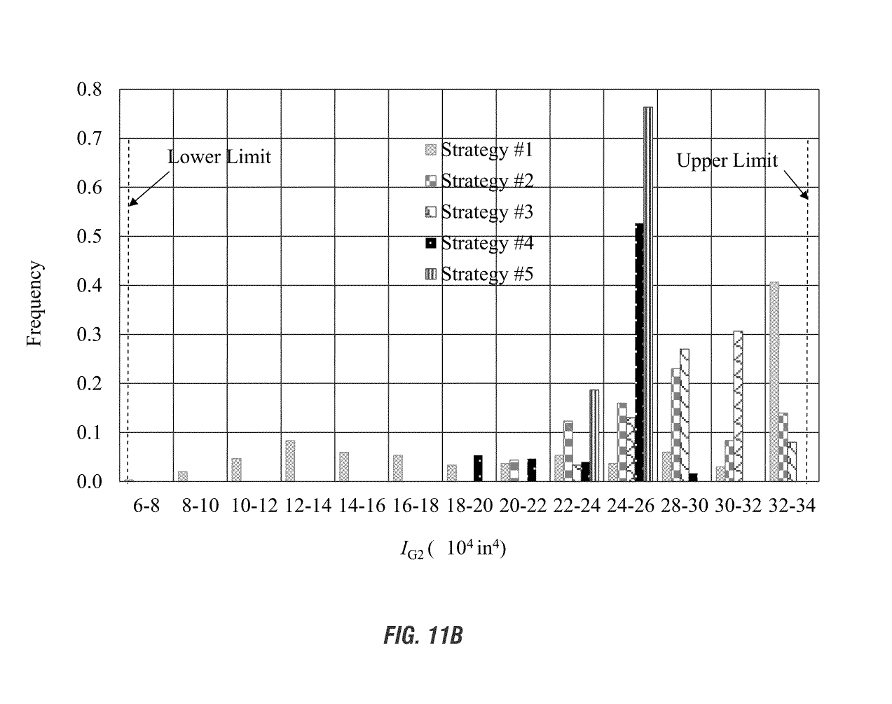

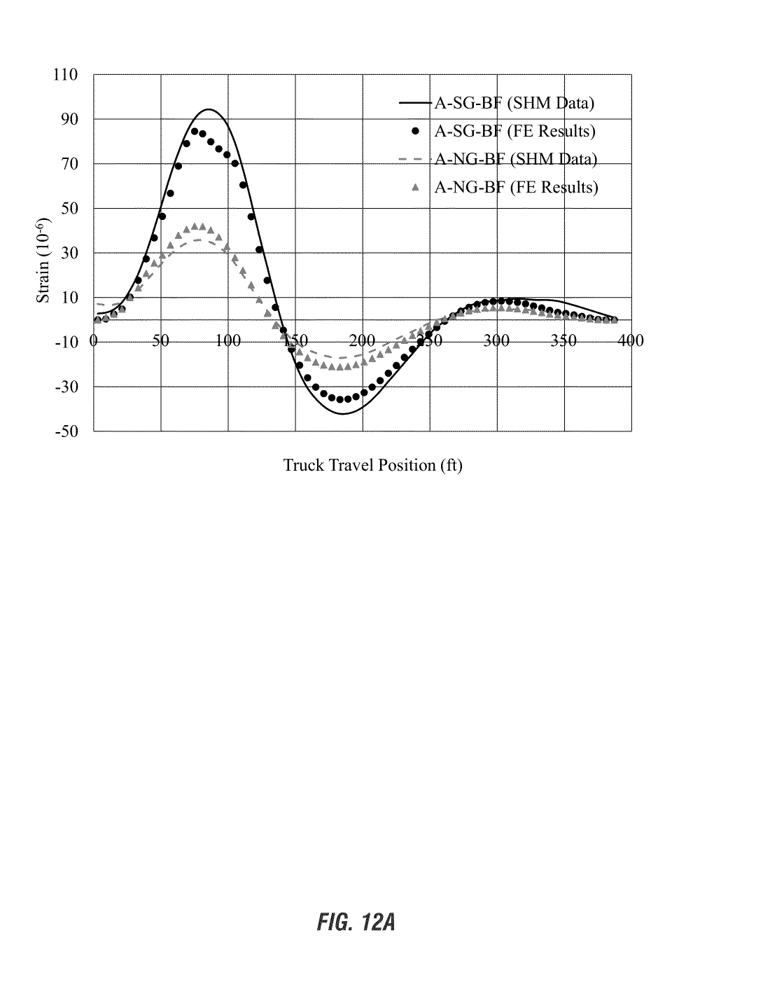

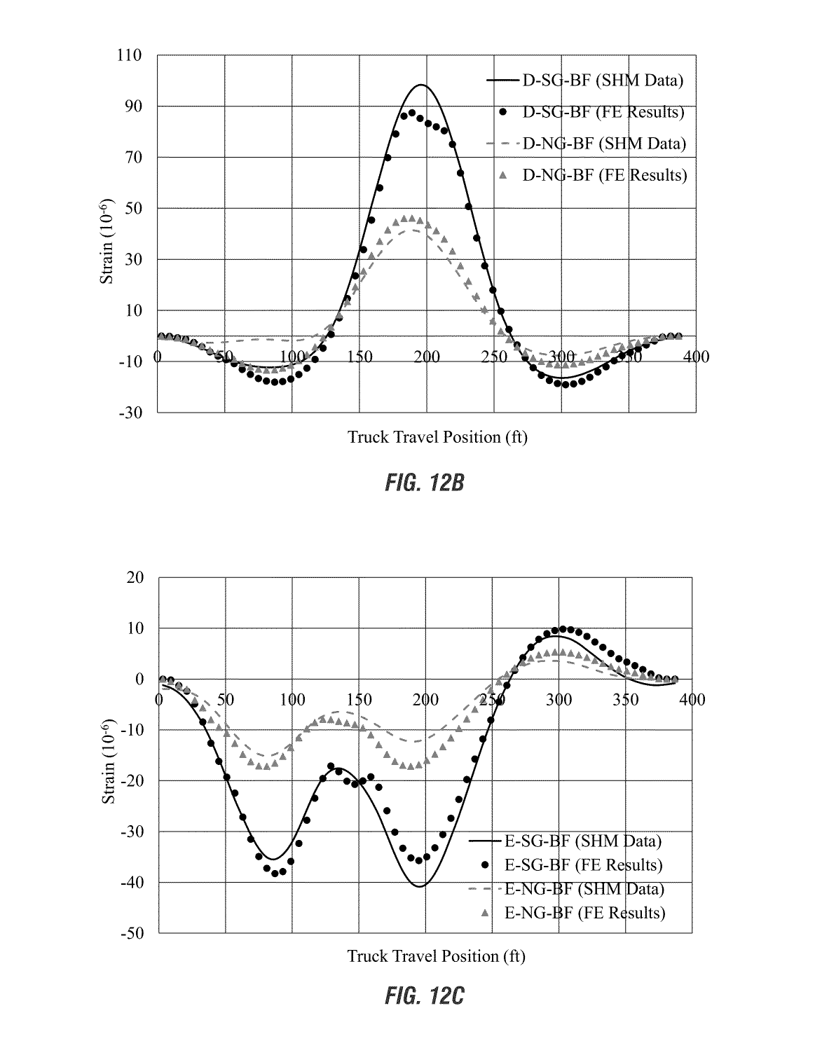

FIG. 10 shows that the wide spread of minimum rating factor ranging from 1.15 to 1.55 are calculated using strategy #1, while smaller spread of minimum rating factor ranging from 1.25 to 1.4 are obtained using strategy #2, #3, #4, or #5. Frequency histograms are plotted for I_{G1} and I_{G2}, as shown in FIGS. 11A and 11B, respectively. FIGS. 11A and B indicates that I_{G1} and I_{G2} approach their upper limits in more than 40% of runs of the FE model calibration and sometimes approach their lower limits when sampling strategy #1 is used; I_{G1} and I_{G2} approach their upper limits in more than 10% of runs of the FE model calibration when sampling strategy #2 or #3 is used. Sampling strategies #4 and #5 appear to be the best of the five strategies since I_{G1} and I_{G2} never approach lower or upper limits using these strategies. Note that, for example, bridge parameters might not be completely calibrated when the lower or upper limits are approached. However, the parameter limits may be needed because unrealistic bridge parameters are not expected in the engineering sense. Strategy #4 may be recommended for automated bridge load rating determination using ambient traffic since variations of ten batches of strain time histories are taken into account. One of 300 calibrations using strategy #4 with percent error of 2.1%, scale error of 3.3% and correlation coefficient of 0.9899 is taken as an example. The truck randomly selected for this calibration from the WIM database has the gross vehicle weight of 75.64 kip (336.5 kN), weight of axle #1, #2, #3, #4 and #5 of 11.88, 15.37, 16.13, 15.99, and 16.27 kip (52.8, 68.4, 71.8, 71.1, 72.4 kN), respectively, axle spacing #1, #2, #3, and #4 of 13.8, 4.3, 28.5, and 4.1 ft (4.21, 1.31, 8.69, and 1.25 m), respectively. The batch of strain time histories calculated using FE modeling are in good agreement with those randomly selected from test data, as shown in FIG. 12A, 12B, 12C for sections A, D and E respectively.

### SUMMARY AND CONCLUSIONS

The present disclosure provides automated methods and systems for determining bridge load ratings using ambient traffic, including an Automated Ambient Traffic Approach for determining load ratings of steel girder bridges under ambient traffic. Using ambient traffic for bridge model calibration, the events with one five-axle truck in the south lane may be extracted from the SHM system records. The truck/vehicle axle spacings and travel position may be determined using the strains recorded by deck bottom sensors. In one aspect, the truck/vehicle is deemed to travel with transverse position of lane center minus/plus 2 ft (0.61 m) following a uniform distribution. Accounting for the uncertainties of gross vehicle weight and axle weight, five sampling strategies may be used, for example, to select random batches of strain time histories based on girder peak strain and select random trucks from the WIM database based on the range of gross vehicle weight along with the detected axle spacings.

In one experimental approach, FE modeling of an example three-span, two-girder, and two-lane steel girder/concrete deck (US-30) bridge is described. Initially, load rating of the example bridge using the Traditional Known Truck Approach provides information for validating the adequacy of the methods and systems of the present disclosure, including an Automated Ambient Traffic Approach. One or more of the following conclusions may be made from the load rating using known trucks/vehicles:
Small errors including percent error and scale error and good correlations result.
The bridge model calibration and load rating may not be sensitive to the truck speed and travel lane.
The rating factors can be well determined although the bridge parameter values are dispersed to some extent.

Calibration and load rating results using, for example, one or more embodiments of the present disclosure, including the Automated Ambient Traffic Approach, with different sampling strategies are compared with those using the Traditional Known Truck Approach. The mean and standard deviation of converged parameter values, statistical values, and minimum rating factors may, for purposed of illustration, be calculated for 300 runs of calibration and load rating using each sampling strategy. The following conclusions, amongst others, may be drawn:
Using sampling strategies #2, #3, #4, or #5, the means and standard deviations of the four statistical values and minimum rating factors are comparable to those obtained using known trucks/vehicles;
Unacceptable mean and standard deviation of percent and scale errors may be derived using the sampling strategy #1;
Small spread of minimum rating factor is obtained using strategy #2, #3, #4, or #5, but only optionally strategy #1.
Sampling strategies #4 and #5 exhibit some of the best properties of the five strategies, and sampling strategy #4 with ten batches of strain time histories with strain peaks higher than 90% of maximum girder strain peak and 30 trucks with weights higher 90% of maximum gross vehicle weight is at least one preferred approach in the case where variations of ten batches of strain time histories are taken into account.

The present invention is not to be limited to the particular embodiments described herein. In particular, the present invention contemplates numerous variations in the type of ways in which embodiments of the invention may be applied to automated methods and systems for determining bridge load ratings using ambient traffic. The foregoing description has been presented for purposes of illustration and description. It is not intended to be an exhaustive list or limit any of the disclosure to the precise forms disclosed. It is contemplated that other alternatives or exemplary aspects that are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

### REFERENCES

American Association of State Highway and Transportation Officials (AASHTO). (1996). Standard Specifications for Highway Bridges, 16th ed., Washington, D.C., 412 pp.
Bridge Diagnostics, Inc. (BDI) (2003). Integrated Approach to Load Testing Instruction Manual. Bridge Diagnostics, Inc., Boulder, Colo., 46 pp.
Chajes M J, Mertz D R, and Commander B. (1997). “Experimental load rating of a posted bridge.” J. Bridge Eng., 2(1), 1-10.
Davids, W. G., Poulin, T. J., and Goslin, K. (2012). “Finite-Element Analysis and Load Rating of Flat Slab Concrete Bridges.” Journal of Bridge Engineering, posted ahead of print Dec. 15, 2012, doi: 10.1061/(ASCE)BE.1943-5592.0000461.
Lu P. (2008). “A statistical based damage detection approach for highway bridge structural health monitoring.” Ph.D. Thesis, Iowa State University, Ames, Iowa
Samuelson A. (2007). “Evaluation of a structural testing system.” MS thesis, Iowa State University, Ames, Iowa
Sanayei, M., Phelps, J., Sipple, J., Bell, E. and Brenner, B. (2012). “Instrumentation, Nondestructive Testing, and Finite-Element Model Updating for Bridge Evaluation Using Strain Measurements.” J. Bridge Eng., 17(1), 130-138.
Seo J., Phares B., Lu P., Wipf T. and Dahlberg J (2013). “Bridge rating protocol using ambient trucks through structural health monitoring system.” Engineering Structures, 46, 569-580.
Wipf, T. J., Phares, B. M., Klaiber, F. W., and Wood, D. (2003). “Evaluation of a Bridge Load Testing/Rating System.” Proceedings of the 10th International Conference and Exhibition Structural Faults and Repair Conference, Held London.

What is claimed is:

1. An in-situ method for determining bridge load ratings under ambient traffic, comprising:
installing one or more gauges on one or more bridge support members;
selecting a batch of readings from the one or more gauges resulting for a detected vehicle;
selecting one or more vehicles from a database based on one or more parameters of the detected vehicle;
calibrating a bridge load rating model based on at least one factor relating to the collected batch of strain readings and the selected one or more vehicles; and
acquiring a bridge load rating distribution from the calibrated bridge load rating model.

2. The method of claim 1 wherein the one or more gauges comprise strain gauges and the one or bridge support members comprises girders.

3. The method of claim 1 further comprising:
randomly sampling from the batch of readings one or more strain time histories based on a girder peak strain.

4. The method of claim 1 further comprising:
randomly selecting from the one or more vehicles in the database based on the one or more parameters comprising a range of gross vehicle weights and detected axle spacings.

5. The method of claim 1 wherein the database comprises a historical weight-in-motion (WIM) database.

6. The method of claim 1 wherein the one or more parameters comprise at least on of:
a. axle spacing;
b. travel position;
c. gross weight;
d. axle weight;
e. transverse position.

7. The method of claim 1 further comprising:
calibrating the bridge load rating model by minimizing differences between measured and computed strain readings using least squares.

8. The method of claim 1 further comprising:
acquiring the batch of readings during ambient traffic flow.

9. A system for in-situ determinations of bridge load ratings under ambient traffic, comprising:
one or more desk bottom sensors operably connected to one or more bridge support members;
a data store with a batch of sensor readings from the one or more deck bottom sensors, wherein said batch of sensor readings are for a detected vehicle;
a database having one or more vehicles with one or more parameters associated with the detected vehicle;
a bridge load rating model based on at least one factor relating to the batch of sensor readings and the one or more vehicles representative of the detected vehicle; and
a bridge load rating distribution output by the bridge load rating model.

10. The system of claim 9 wherein the one or more deck bottom sensors comprise one or more strain gauges and the one or more bridge support members comprise one or more bridge girders.

11. The system of claim 9 further comprising:
a sensor reading sampling algorithm having at least one sampling parameter comprising one or more strain time histories based on a girder peak strain.

12. The system of claim 11 wherein the strain time histories comprise strain peaks at least 90% of the girder peak strain.

13. The system of claim 9 wherein the database comprises a historical weight-in-motion (WIM) database for the one or more vehicles.

14. The system of claim 9 further comprising:
a vehicle sampling algorithm having at least one sampling parameter comprising a range of gross vehicle weights and detected axle spacings.

15. The system of claim 14 wherein the range of gross vehicle weights comprises weights at least 90% of a maximum gross vehicle weight.

16. An in-situ method for determining bridge load ratings under ambient traffic, comprising:
installing one or more strain gauges on one or more bridge girders;
acquiring a batch of strain readings from the one or more strain gauges;
randomly sampling one or more strain time histories from the batch of strain readings based on a girder peak strain;
accessing a database with one or more stored vehicles and stored vehicle parameters;
randomly selecting one or more vehicles from the database based on the one or more stored vehicle parameters;
calibrating a bridge load rating model based on the one or more randomly sampled strain time histories and the randomly selected one or more vehicles; and
acquiring a bridge load rating distribution from the calibrated bridge load rating model.

17. The method of claim 16 wherein the stored vehicle parameters comprise a range of gross vehicle weights and detected axle spacings.

18. The method of claim 16 wherein the database comprises a historical weight-in-motion (WIM) database for the one or more stored vehicles and stored vehicle parameters.

19. The method of claim 16 wherein the stored vehicle parameters comprise at least on of:
a. axle spacing;
b. travel position;
c. gross weight;
d. axle weight;
e. transverse position.

20. The method of claim 16 further comprising:
calibrating the bridge load rating model by minimizing differences between measured and computed strain readings using least squares.
